(19) United States
(12) Patent Application Publication
(10) Pub. No.: US 2009/0148249 A1
(43) Pub. Date: Jun. 11, 2009

(54) PCBN Cutting Tool Components

(76) Inventors: Cornelius Johannes Pretorius, County Clare (IE); Peter Michael Harden, Limerick County (IE); Tom Patrick Howard, County Clare (IE)

Correspondence Address: FROMMER LAWRENCE & HAUG, 745 FIFTH AVENUE- 10TH FL., NEW YORK, NY, 10151, US

(21) Appl. No.: 12/096,974

(22) PCT Filed: Dec. 12, 2006
(86) PCT No.: PCT/IB2006/003563

§ 371 Date: Aug. 13, 2008

(30) Foreign Application Priority Data
Dec. 12, 2005 (ZA) 2005-10083

(51) Int. Cl. B23B 27/14

(52) U.S. Cl. 408/144; 407/119

(57) ABSTRACT

A cutting tool component (10) comprising a body comprising a cemented carbide substrate (12) and having at least one working surface (14), the at least one working surface presenting a cutting edge or area (16) for the body, the at least one working surface (14) comprises PCBN adjacent the cutting edge or area (16) and extending to a depth of no greater than 0.2 mm from the at least one working surface and wherein the substrate (12) has a thickness of 1.0 to 40 mm.

### BACKGROUND OF THE INVENTION

This invention relates to ultra-hard cutting tool components and more particularly PCBN cutting tool components.

Boron nitride exists typically in three crystalline forms, namely cubic boron nitride (CBN), hexagonal boron nitride (hBN) and wurtzitic cubic boron nitride (wBN). Cubic boron nitride is a hard zinc blend form of boron nitride that has a similar structure to that of diamond. In the CBN structure, the bonds that form between the atoms are strong, mainly covalent tetrahedral bonds.

CBN has wide commercial application in machining tools and the like. It may be used as an abrasive particle in grinding wheels, cutting tools and the like or bonded to a tool body to form a tool insert using conventional electroplating techniques.

CBN may also be used in bonded form as a CBN compact, also known as PCBN (polycrystalline CBN). CBN compacts comprise sintered masses of CBN particles. When the CBN content exceeds 80 percent by volume of the compact, there is a considerable amount of CBN-to-CBN contact. When the CBN content is lower, e.g. in the region of 40 to 60 percent by volume of the compact, then the extent of direct CBN-to-CBN contact is limited.

CBN compacts will generally also contain a binder containing one or more ceramic phase(s) in compacts containing aluminium, cobalt, nickel, tungsten and titanium.

CBN compacts tend to have good abrasive wear, are thermally stable, have a high thermal conductivity, good impact resistance and have a low coefficient of friction when in contact with a workpiece. The CBN compact, with or without substrate, is often cut into the desired size and/or shape of the particular cutting or drilling tool to be used and then mounted on to a tool body utilising brazing techniques.

When the CBN content of the compact is less than 70 percent by volume, the matrix phase, i.e. the non-CBN phase, will typically also comprise an additional or secondary hard phase, which may be ceramic in nature. Examples of suitable ceramic hard phases are carbides, nitrides, borides and carbonitrides of a Group 4, 5 or 6 (according to the new IUPAC format) transition metal aluminium oxide and mixtures thereof. The matrix phase constitutes all the ingredients in the composition excluding CBN.

CBN compacts may be bonded directly to a tool body in the formation of a tool insert or tool. However, for many applications it is preferable that the compact is bonded to a substrate/support material, forming a supported compact structure, and then the supported compact structure is bonded to a tool body. The substrate/support material is typically a cemented metal carbide that is bonded together with a binder such as cobalt, nickel, iron or a mixture or alloy thereof. The metal carbide particles may comprise tungsten, titanium or tantalum carbide particles or a mixture thereof.

A known method for manufacturing the polycrystalline CBN compacts and supported compact structures involves subjecting an unsintered mass of CBN particles together with a powdered matrix phase, to high temperature and high pressure conditions, i.e. conditions at which the CBN is crystallographically or thermodynamically stable, for a suitable time period. Typical conditions of high temperature and pressure which are used are temperatures in the region of 1100° C. or higher and pressures of the order of 2 GPa or higher. The time period for maintaining these conditions is typically about 3 to 120 minutes.

CBN compacts with CBN content more than 70 volume percent are known as high CBN PCBN materials. They are employed widely in the manufacture of cutting tools for machining of grey cast irons, white cast irons, powder metallurgy steels, tool steels and high manganese steels. In addition to the conditions of use, such as cutting speed, feed and depth of cut, the performance of the PCBN tool is generally known to be dependent on the geometry of the workpiece and in particular, whether the tool is constantly engaged in the workpiece for prolonged periods of time, known in the art as “continuous cutting”, or whether the tool engages the workpiece in an intermittent manner, generally known in the art as “interrupted cutting”.

Commercially available PCBN cutting tools all have sintered PCBN layers with thicknesses above 0.2 mm. These thick PCBN layers are difficult and expensive to process. The cost of manufacture of a PCBN cutting tool has thus made it too expensive to compete successfully in the carbide cutting tool market. For PCBN to be considered for typical carbide applications, it has to be easier and cheaper to process and have higher chip resistance, while still outperforming carbide in terms of wear resistance.

U.S. Pat. No. 5,697,994 describes a cutting tool for woodworking applications comprising a layer of PCD or PCBN on a cemented carbide substrate. The PCD is generally provided with a corrosion resistant or oxidation resistant adjuvant alloying material in the bonding phase. An example is provided wherein the PCD layer is 0.3 mm in thickness. For PCBN the layer thickness is preferably 0.3 to 0.9 mm.

### SUMMARY OF THE INVENTION

A cutting tool component of the invention comprises a body comprising a cemented carbide substrate and having at least one working surface, the at least one working surface presenting a cutting edge or area for the body, characterized in that the at least one working surface comprises PCBN adjacent the cutting edge or area and extending to a depth of no greater than 0.2 mm from the at least one working surface and wherein the substrate has a thickness of 1.0 to 40 mm.

In one preferred embodiment of the invention, the cutting tool component body comprises a cemented carbide substrate and an ultra-thin layer of PCBN bonded to a major surface of the substrate, the ultra-thin layer of PCBN having a thickness of no greater than, generally less than, 0.2 mm and the substrate has a thickness between 1.0 to 40 mm.

In an alternative preferred embodiment of the invention, one or more intermediate layers is/are located between the cemented carbide substrate and the layer of PCBN, preferably based on a ceramic, metal or ultra-hard material or combination thereof that is softer than the PCBN.

In another alternative preferred embodiment of the invention, the cutting tool component body comprises a cemented carbide substrate having a working surface presenting a cutting edge or area for the tool component and having a plurality of grooves or recesses extending into the substrate from the working surface, and a plurality of strips or pieces of ultra-hard material located in the respective grooves or recesses, the arrangement being such that the PCBN extends to a depth of no greater than 0.2 mm from the working surface and forms a part of the cutting edge or area of the tool component.

The thickness or depth of the PCBN layer or inserts is preferably from 0.001 to 0.15 mm.

The PCBN optionally contains a second phase comprising a metal or metal compound selected from the group comprising aluminium, cobalt, iron, nickel, platinum, titanium, chromium, tantalum, copper, tungsten or an alloy or mixture thereof.

### BRIEF DESCRIPTION OF THE DRAWINGS

The invention will now be described in more detail, by way of example only, with reference to the accompanying drawings in which:

FIG. 1 is a partial perspective view of a first embodiment of a cutting tool component of the invention:

FIG. 2 is a partial perspective view of a second embodiment of a cutting tool component of the invention:

FIG. 3 is a partial perspective view of a third embodiment of a cutting tool component of the invention:

FIG. 4 is a schematic side view of a cutting tool component of the invention in use, illustrating the “self-sharpening” effect thereof;

FIG. 5 is a graph showing chip size under light interrupted machining conditions for two PCBN cutting tools; and

FIG. 6 is a box plot illustrating fracture resistance for two PCBN tool cutting tools.

### DESCRIPTION OF PREFERRED EMBODIMENTS

The object of the present invention is to provide an engineered PCBN cutting tool with properties between cemented carbide and PCBN.

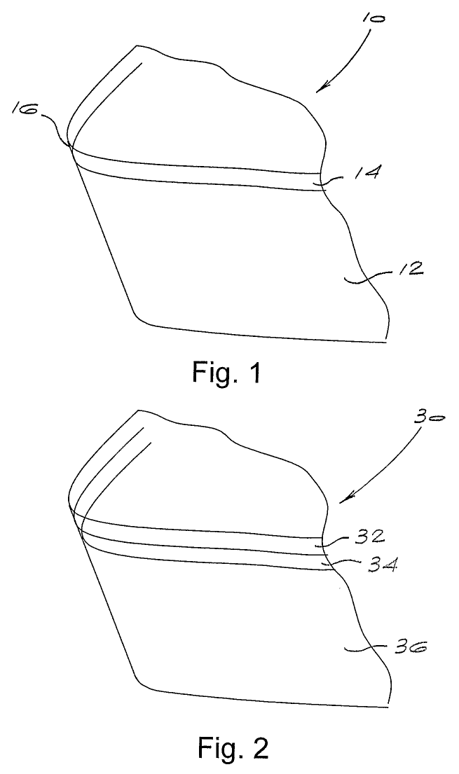

The object is addressed by providing a cutting tool component 10, as illustrated for example in FIG. 1, which comprises a cemented carbide substrate 12 with an ultra-thin layer 14 of PCBN, which has a thickness of no greater than, generally less than 0.2 mm, preferably between 0.001-0.15 mm and wherein the substrate has a thickness from 1.0-40 mm. Such a cutting tool component is produced by high temperature high pressure synthesis. The thickness of the ultra-thin hard layer 14 at the cutting edge 16 is the critical parameter determining the properties of the material and allows for cutting with both the top hard layer 14 (PCBN) and the carbide substrate 12. Wear resistance, chip resistance, cutting forces, grindability, EDM ability and thermal stability are all properties affected by the thickness of the hard layer. Various methods for producing PCBN cutting tools with cemented carbide substrates exist and are well known in the industry.

The ultra-thin hard layer together with the softer substrate results in a “self-sharpening” behaviour during cutting, which in turn reduces the forces and temperatures at the cutting edge. The hard layer is a high or low CBN content PCBN, of the type described above. The thickness of the hard layer preferably varies between 0.001-0.15 mm, depending on the required properties for specific applications.

Referring to the tool component 30 of FIG. 2, the ultra-thin hard layer 32 can also be bonded to an intermediate softer layer 34 of metal, ceramic, or ultra-hard material which in turn is bonded to the cemented carbide substrate 36.

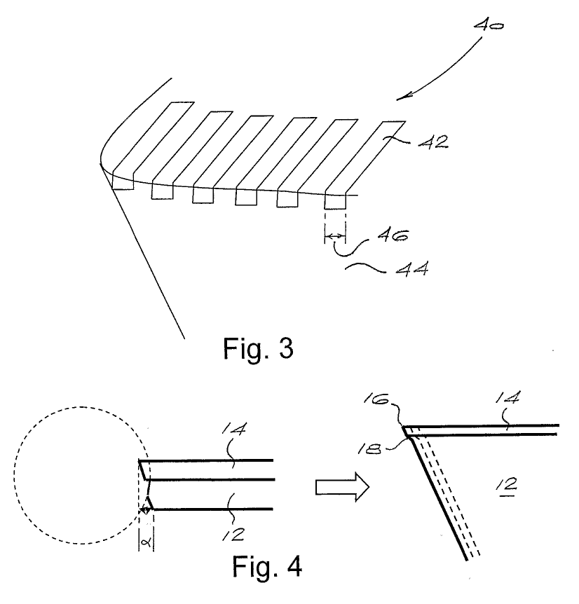

Alternatively, referring to the tool component 40 as illustrated in FIG. 3, the ultra-thin hard layer may also be in the form of strips 42 (vertical layers) across the cutting tool alternating with the substrate material 44, where the width 46 of the strips is between 10 and 50 microns. Other arrangements where recessed pieces of PCBN are located in the substrate material are also envisaged.

The substrate material can be selected from tungsten carbides, ultra-fine grain tungsten carbides, titanium carbides, tantalum carbides and niobium carbides. Methods for producing cemented carbides are well known in the industry. Because cutting is done with both the PCBN and the carbide, the selection of the substrate is another variable which can be changed in order to alter the properties of the cutting element to suit different applications.

In some applications, it may be preferable to provide a substrate having a profiled or shaped surface, which results in an interface with a complimentary shape or profile.

From a processability perspective the critical feature of the invention is the ultra-thin hard layer which will reduce the processing cost of PCBN cutting tools.

In terms of performance the critical feature of the invention is to adjust the hard layer thickness so that the desired properties can be achieved and also to ensure that a “self-sharpening” effect takes place during cutting. This could mean adding a softer ceramic or metal intermediate layer just below the PCBN. This means that when the wear progresses through the hard layer at some stage during the cutting process, the cutting will be done by both the hard layer and the substrate and/or the intermediate layer. Conventional tools all have a hard layer thickness above 0.2 mm, and hence the substrate never comes in contact with the workpiece (since tool life criteria is VB_{B}max=0.2−0.3 mm) and the properties and behaviour of the tool is that of the hard layer only.

As illustrated in FIG. 4, as long as cutting is done by the hard layer 14, the wear rate will be that of the hard layer. As soon as the wear extends into the carbide substrate 12 and the cutting is done by both the PCBN and the carbide, the wear rate will increase to include both that of the substrate and of the hard layer. Thus, the thicker the hard layer, the longer the wear rate is controlled by the wear resistance of the hard layer and the longer the tool life. Having an ultra-thin hard layer where the cutting is done by both the hard layer and the carbide gives a wear resistance between that of carbide and the hard layer. By varying the thickness of the hard layer (between 0.001-0.15 mm) it allows one to change the properties and the tool life of the material to what is required for a specific application. This allows one to provide signature products for specific applications. The thinner the hard layer, the closer the cutting tool properties will be to that of the substrate. However, due to the “self-sharpening” effect of the engineered cutting tool, the cutting process and wear rate are dominated by the hard layer.

A major benefit of cutting with both the ultra-thin hard layer 14 and the substrate 12 is the “self-sharpening” effect it has on the tool. As illustrated in FIG. 4, it can be seen that because the material of the substrate 12 is much softer than the top hard layer 14, it wears away quicker than the hard layer 14, forming a “lip” 18 between the hard layer and the bottom layer at the edge 16. This allows the tool to cut predominantly with the top hard layer 14, minimising the contact area with the workpiece which ultimately results in lower forces and temperatures at the cutting edge 16. It also means that when the tool wears it keeps a clearance angle (α) allowing it to cut more efficiently. This wear behaviour is ideal for roughing applications and wood composite machining, especially in saw blade applications, where dimensional tolerances are not so critical. It is also beneficial in oil drilling applications where a sharp cutter results in a lower “weight on bit” and higher penetration rates. It will also be beneficial in the machining of ferrous materials.

Another benefit of ultra-thin hard layers is the improved chip resistance it gives to the tool. Thicker layers have higher residual stresses and are more susceptible to chipping and fracture. Also, if chipping does occur, the carbide substrate will arrest the crack and stop it from getting bigger than the thickness of the top hard layer.

### Effect on Processability

All processing (EDM, EDG, grinding) is easier and faster as the top hard layer becomes thinner. Having ultra-thin hard layers will shorten processing times.

As explained earlier conventional PCBN compacts are manufactured with PCBN layer thicknesses >0.2 mm in order for the cutting to be done by the hard layer only. However, during the synthesis of such thick layers, the compact often bows because of the thermal expansion differences between that of PCBN and the carbide substrate. This results in additional processing (mechanical grinding, EDG or lapping) to get the compact back to flatness. With ultra-thin hard layers, bending of the disc is minimised and additional processing is not required. This allows for the production of near-net shape PCBN compacts.

The invention will now further be discussed, by way of example only, with reference to the following non-limiting examples. These examples show the advantages of an ultra-thin PCBN cutting tool component. The PCBN cutting tool components used in the examples were made by PCBN manufacturing methods well known in the art and as described above.

### Example 1

### AISI4340 ‘Drilled’ Light Interrupted Machining Test

The test is believed to be very representative of hard machining. Two PCBN cutting tool components of the type described above were used in the test. The one had an ultra-thin PCBN layer 0.1 mm in thickness and the other a PCBN layer of 0.5 mm thickness. The maximum chip size was recorded. The test conditions were as follows:

| | | Depth of | Cutting | |
|---|---|---|---|---|
| | Feed, f | cut, aₚ | Speed, v_{c} | Insert |
| Test | (mm) | (mm) | (m/min) | Geometry |
| (AISI) 4340 | 0.15 | 0.2 | 150 | SNMN090308 |
| Drilled | | | | S0220 |
| Face- | | | | |
| Turning | | | | |

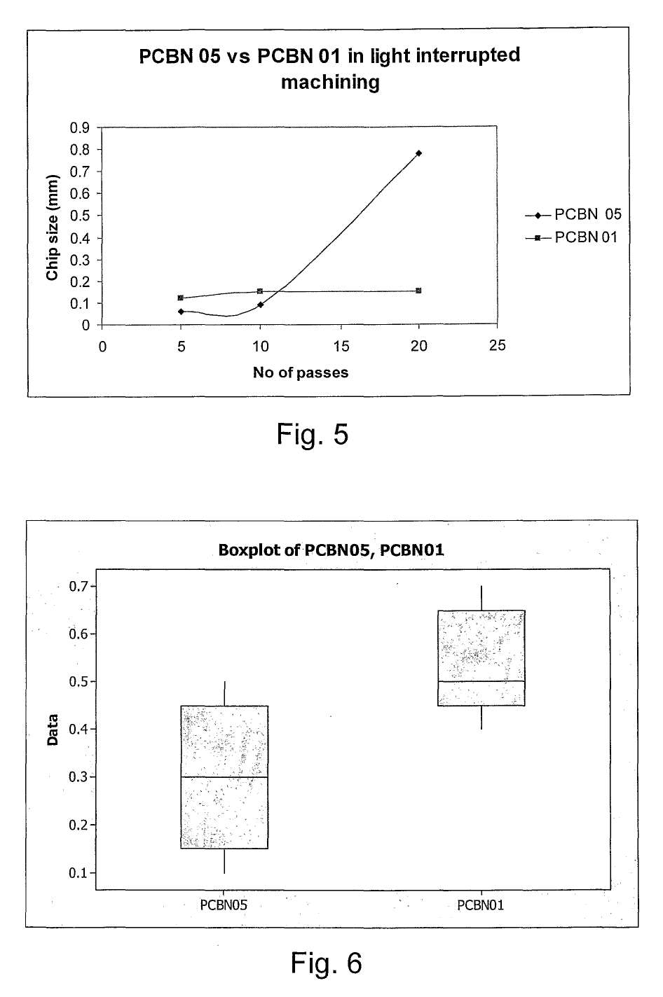

From the graph of FIG. 5 it can be seen that the ultra-thin PCBN exhibits less fracture than the thicker 0.5 mm layer. As was the case with PCD the actual chip on the edge gets “arrested” once the fracture path reaches the carbide. From there onwards wear is the critical feature and not fracture.

### Example 2

### Roughing Example: Catastrophic Fracture Resistance Machining Compact Graphite Cast Iron (CGI)

An interrupted milling operation was performed using the same two PCBN cutting tool components of Example 1 whereby the conditions and workpiece were chosen as to minimise any wear events and in return promote fracture. The feed per tooth was increased from 0.1 to 0.2 to 0.3 etc until catastrophic failure of the nose was observed. The feed per tooth represent the load on the cutting edge and is therefore a suitable fracture resistance indicator. The test conditions that were used are as follow:
Workpiece material: GJV 400 (>95% Pearlite, 10% nodularity)
Cutting Speed: 300 m/min
Feed per tooth: varied
DOC: 1 mm
WOC: ½ the block
Relief angle: 18 deg
Rake angle: 0 deg

From the Box-plot of FIG. 6 it appears that the 01 layer has a higher fracture resistance than the 05 layer. Since this data is not normally distributed, a Kruskal-Wallis Statistical test was performed in order to evaluate whether this improvement is significant. Since the P-value is smaller than 0.05 it can be concluded that the thin layer is significantly more fracture resistant than the 0.5 mm layer

### Kruskal-Wallis Test: Fz Failure Versus Tool Material

Kruskal-Wallis Test on Fz failure

| Tool | | | Ave | |
|---|---|---|---|---|
| Material | N | Median | Rank | Z |
| PCBN01 | 5 | 0.5000 | 7.5 | 2.09 |
| PCBN05 | 5 | 0.3000 | 3.5 | −2.09 |
| Overall | 10 | | 5.5 | |

H = 4.36 DF = 1 P = 0.037
H = 4.50 DF = 1 P = 0.034 (adjusted for ties)

1. A cutting tool component comprising a body comprising a cemented carbide substrate and having at least one working surface, the at least one working surface presenting a cutting edge or area for the body, wherein at least one working surface comprises PCBN adjacent the cutting edge or area and extending to a depth of no greater than 0.2 mm from the at least one working surface and wherein the substrate has a thickness of 1.0 to 40 mm.

2. A tool component according to claim 1 wherein the body comprises a cemented carbide substrate and an ultra-thin layer of PCBN bonded to a major surface of the substrate, the ultra-thin layer of PCBN having a thickness of no greater than 0.2 mm and the substrate has a thickness of between 1.0 and 40 mm.

3. A tool component according to claim 2 wherein the thickness of the ultra-thin layer of PCBN is less than 0.2 mm.

4. A tool component according to claim 2 wherein one or more intermediate layers is/are located between the cemented carbide substrate and layer of PCBN, the intermediate layer being softer than the PCBN of the ultra-thin layer.

5. A tool component according to claim 4 wherein the intermediate layer or layers is/are ceramic, metal or ultra-hard material or a combination thereof.

6. A tool component according to claim 1 wherein the body comprises a cemented carbide substrate having a working surface presenting a cutting edge or area for the tool component and having a plurality of grooves or recesses extending into the substrate from the working surface, and a plurality of strips or pieces of PCBN located in the respective grooves or recesses, the arrangement being such that the PCBN extends to a depth of no greater than 0.2 mm from the working surface and forms part of the cutting edge or area of the tool component.

7. A tool component according to claim 1 wherein the thickness or depth of the layer, pieces or strips of PCBN is from 0.001 to 0.15 mm.

8. A tool component according to claim 1 substantially as herein described with reference to any one of FIGS. 1 to 6 of the accompanying drawings.

9. A tool component according to claim 3 wherein one or more intermediate layers is/are located between the cemented carbide substrate and layer of PCBN, the intermediate layer being softer than the PCBN of the ultra-thin layer.

10. A tool component according to claim 2 wherein the thickness or depth of the layer, pieces or strips of PCBN is from 0.001 to 0.15 mm.

11. A tool component according to claim 3 wherein the thickness or depth of the layer, pieces or strips of PCBN is from 0.001 to 0.15 mm.

12. A tool component according to claim 4 wherein the thickness or depth of the layer, pieces or strips of PCBN is from 0.001 to 0.15 mm.

13. A tool component according to claim 5 wherein the thickness or depth of the layer, pieces or strips of PCBN is from 0.001 to 0.15 mm.

14. A tool component according to claim 6 wherein the thickness or depth of the layer, pieces or strips of PCBN is from 0.001 to 0.15 mm.
